(19) United States
(12) Patent Application Publication
(10) Pub. No.: US 2009/0272581 A1
(43) Pub. Date: Nov. 5, 2009

(54) LOAD DISTRIBUTION FOR MULTI-STAGE THRUST BEARINGS

(75) Inventors: James Edmond Beylotte, Crosby, TX (US); Jeffrey N. Dodge, Spring, TX (US); Taral Patel, Houston, TX (US)

Correspondence Address: OSHA, LIANG LLP / SMITH, TWO HOUSTON CENTER, 909 FANNIN STREET, SUITE 3500, HOUSTON, TX, 77010, US

(73) Assignee: Smith International, Inc., Houston, TX (US)

(21) Appl. No.: 12/433,387

(22) Filed: Apr. 30, 2009

Related U.S. Application Data
(60) Provisional application No. 61/049,297, filed on Apr. 30, 2008.

(51) Int. Cl. F16C 17/04; E21B 4/00; E21B 4/02; F16C 33/00

(52) U.S. Cl. 175/107; 175/92; 384/424

(57) ABSTRACT

A drilling motor includes an upper end connection adapted to connect to a drill string, and a lower end connection adapted to connect to a drill bit, a thrust bearing assembly having a plurality of stages assembled in a stack, each stage including at least one rotating inner bearing subassembly configured to contact at least one corresponding stationary outer bearing subassembly, wherein axial loads among the plurality of stages are substantially equal under normal operating conditions.

### BACKGROUND

1. Field of the Disclosure

Embodiments of the present disclosure relate generally to motors attached to a drillstring and used for drilling an earth formation. More specifically, the embodiments disclosed herein relate to a multi-stage thrust bearing assembly capable of equal load distribution.

2. Background Art

Drilling motors are commonly used to provide rotational force to a drill bit when drilling earth formations. Drilling motors used for this purpose are typically driven by drilling fluids pumped from surface equipment through the drillstring. This type of motor is commonly referred to as a mud motor. In use, the drilling fluid is forced through the mud motor(s), which extract energy from the flow to provide rotational force to a drill bit located below the mud motors. There are two primary types of mud motors: positive displacement motors (“PDM”) and turbodrills. The following disclosure focuses primarily on turbodrills; however, one of ordinary skill in the art will appreciate that thrust bearings disclosed herein may be similarly used in PDMs.

FIG. 1 shows a prior art turbodrill which is used to provide rotational force to a drill bit. A housing 45 includes an upper connection 40 to connect to the drillstring. Turbine stages 80 are disposed within the housing 45 to rotate a shaft 50. A stage in this context may be defined as a mating set of rotating and stationary parts. A turbine stage typically includes a bladed rotor and a bladed stator. At a lower end of the turbodrill, a drill bit 90 is attached to the shaft 50 by a lower connection (not shown). A radial bearing 70 is provided between the shaft 50 and the housing 45. Stabilizers 60 and 61 disposed on the housing 45 help to keep the turbodrill centered within the wellbore. A turbodrill uses turbine stages 80 to provide rotational force to drill bit 90. In operation, drilling fluid is pumped through a drillstring (not shown) until it enters the turbodrill. The drilling fluid passes through a rotor/stator configuration of turbine stages 80, which rotates shaft 50 and ultimately drill bit 90.

While providing rotational force to the shaft 50 through the rotor (not shown), the turbine stages 80 also produce a downward axial force (thrust) from the drilling fluid. Upward axial force results from the reaction force of the drill bit 90, also called weight on bit “WOB.” To transfer axial loads between the housing 45 and the shaft 50, thrust bearings 10 are provided. As shown in FIG. 2A, multiple stages of thrust bearings 10 are “stacked” in series; FIG. 2A shows a portion of a bearing stack in which four bearing stages can be seen. A bearing stage in this context may comprise a rotating bearing subassembly and a stationary bearing subassembly. A bearing subassembly as defined may simply comprise the bearing itself, for example a bearing comprised of polycrystalline diamond compacts inserted into a ring, or may additionally comprise components, including but not limited to spacers, frames, wear plates, pins, and springs.

It is necessary to positionally arrange the bearing stages in series in order to fit them within the confines of the turbodrills tubular body. Though the bearing stages are positionally in series, the axial load, at least in principle, is carried in parallel by the bearing stages and shared to some extent by each bearing stage. The bearing stages are held in position in the stacks by axial compression. The primary purposes of compression are to allow the components to transfer torque and to provide a sealing force between components. The compression may be maintained by threaded components on one or both ends of the inner and outer bearing stacks. In a free, uncompressed state, all stage lengths may be nominally equal. Ideally, all stages have identical lengths so the load is distributed evenly among all stages.

A limitation of prior art bearings has been that beyond normal manufacturing variances, differences in compressive preloads, working loads, stage component geometry, and materials may cause the stage heights to depart from the “nominally equal” condition when in use to an unequal condition. This unequal condition may degrade the load sharing capacity of the bearing stack. In most cases one of the stacks (typically the inner stack) is less stiff than the other stack. When under load, the less stiff stack deflects more than the stiffer stack, causing unequal load distribution. The stiffness of the stacks is driven by functional and/or structural requirements and limited by space constraints within the surrounding mechanical system. Furthermore, as additional stages are added to accommodate greater working loads, the lengths of the stacks increases and the cumulative effect of unequal stage length increases accordingly, amplifying the problem of unequal load distribution.

Some prior art bearing stacks utilized rubber bearings, and the compliance of the rubber bearings themselves allowed thrust load to be somewhat evenly distributed. With the advent of polycrystalline diamond compact (PDC) bearings, it became necessary to support the bearings on springs to achieve a degree of load sharing. FIG. 2B shows a typical PDC bearing stage in which the stationary bearing is supported by a disc, or Belleville, spring. However, it has been found that in long bearing stacks (for example, more than 10 bearing stages) the cumulative effect of unequal stage length is such that one stack (typically the outer stack) is much longer than the inner stack. In the event that the difference in stack lengths exceeds the travel limits of the springs, the springs at one end of the stack bottom out and the bearings at the other end of the stack share little, or even zero load.

Unequal load sharing or distribution in the thrust bearings may have serious effects on the operation of the turbodrill. First, the higher loaded stages may wear out prematurely and limit the run life of the drill. Second, the load threshold that will cause one or more of the compressive springs to reach its travel limit (solid height) is greatly reduced. Once a compressive spring reaches its solid height, the load for that stage dramatically increases to the extent that catastrophic failure of the contact surfaces is inevitable. Accordingly, there exists a need for improved load distribution among the thrust bearing stages of a turbodrill.

### SUMMARY OF THE DISCLOSURE

In one aspect, embodiments disclosed herein relate to a drilling motor including an upper end connection adapted to connect to a drill string, and a lower end connection adapted to connect to a drill bit, a thrust bearing assembly having a plurality of stages assembled in a stack, each stage including at least one rotating inner bearing subassembly configured to contact at least one corresponding stationary outer bearing subassembly, wherein axial loads among the plurality of stages are substantially equal under normal operating conditions.

In another aspect, embodiments disclosed herein relate to a method of improving a load distribution in thrust bearings of a drilling motor, the method including providing a multi-stage thrust bearing assembly having a plurality of rotating inner bearing subassemblies configured to contact a plurality of stationary outer bearing subassemblies, and providing a bearing subassemblies having substantially equal axial loads under normal operating conditions.

Other aspects and advantages of the invention will be apparent from the following description and the appended claims.

### BRIEF DESCRIPTION OF DRAWINGS

FIG. 1 is an assembly view of a conventional turbo drill.

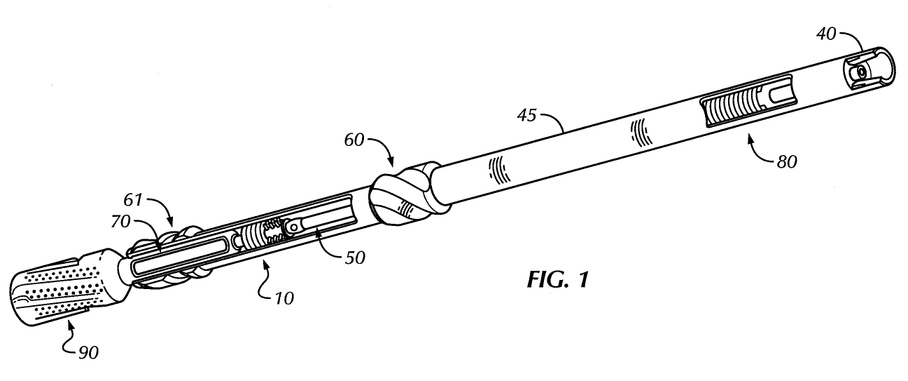

FIG. 2A is a section view of a multi-stage thrust bearing assembly in accordance with embodiments of the present disclosure.

FIG. 2B is a section view of an individual thrust bearing stage in accordance with embodiments of the present disclosure.

FIG. 3 is a chart showing load distributions across multiple stages of a turbodrill in accordance with embodiments of the present disclosure.

### DETAILED DESCRIPTION

In one aspect, embodiments of the present disclosure relate to a turbodrill with improved load sharing in the thrust bearing assembly. An improvement in the load sharing ability of a multi-stage thrust bearing assembly that accounts for individual stage height deflections caused by assembly pre-loads and working loads would be well received in industry.

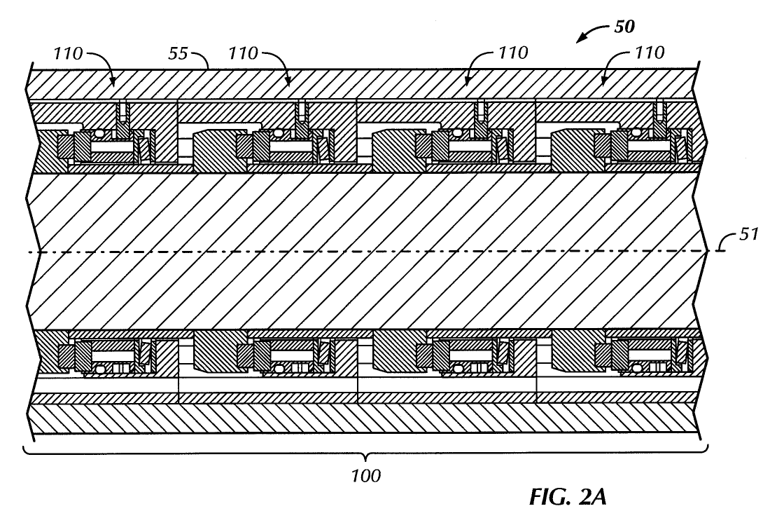

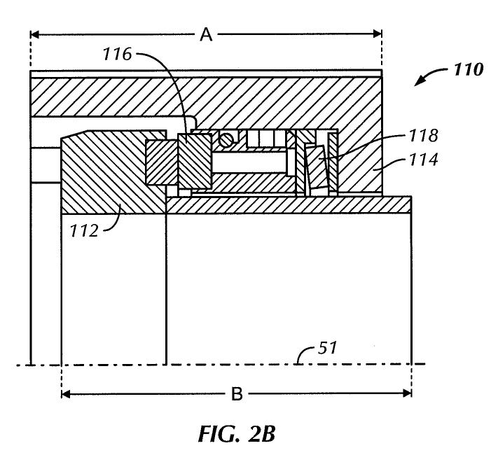

Referring to FIG. 2A, a section view of a thrust bearing assembly 100 in a turbodrill 50 is shown in accordance with embodiments of the present disclosure. Thrust bearing assembly 100 is housed within an outer housing 55 of turbodrill 50, and includes individual stages 110 arranged in a series along a central axis 51 of turbodrill 50. The individual stages 110 may also be referred to as a “stack” when arranged in series in turbodrill 50.

Referring now to FIG. 2B, a section view of an individual stage 110 of thrust bearing assembly 100 is shown in accordance with embodiments of the present disclosure. Stage 110 includes an inner stage 112 (typically rotating) and an outer stage 114 (typically stationary). During operation, axial loads are transferred from inner stage 112 to outer stage 114 or visa versa. Load transfer may occur through low friction, wear resistant contact surfaces 116, typically polycrystalline diamond. A compressive spring 118 is used beneath contact surfaces 116 within each stage 110 to compensate for normal manufacturing variations, alignment, and some load sharing.

Sealing requirements between outer stack 114 and outer housing 55, and inner stack 112 and a shaft (not shown) rotating about central axis 51 of turbodrill 50, determine the amount of compression applied to the inner stack 112 and outer stack 114. The sealing requirements between these components are needed to keep fluid from leaking between them and accumulating between either outer stack 114 and housing 55, or inner stack 112 and the shaft. Likewise, the requirement to transfer torque from one stage to another, through compression load and friction, has been another factor in determining the amount of compression. Embodiments of the present disclosure are provided to address axial load sharing requirements between the multiple thrust bearing stages of the turbodrill. Therefore, in embodiments disclosed herein, axial load sharing requirements are considered in addition to torque transmission and sealing requirements to determine the amount of compression applied to inner stack 112 and outer stack 114 during assembly.

Load distribution, as used herein, may be defined as a spectrum of the axial loads applied to each individual thrust bearing stage during operation of the turbodrill. These axial loads are a result of externally applied working loads that include downward hydraulic thrust and weight on bit. The compressive preload applied to the stacks during assembly affects the sharing, or distribution, of these external loads through the stacks. Embodiments of the present disclosure, either one or a combination thereof, may be employed to improve the load sharing ability of the multi-stage thrust bearing assembly.

Referring still to FIG. 2B, in a first embodiment, the inner stage and the outer stage may be configured to have unequal stage free lengths to improve the load sharing ability of multi-stage thrust bearing 110. As shown, an outer stage 114 length may be defined by an axial length “A” and an inner stage 112 length may be defined by an axial length “B”. Inner stage 112 and outer stage 114 may differ in cross-sectional area, material, and/or length. Therefore, when a compressive load is applied to inner stage 112 and outer stage 114, the deflection rates of the two components may be different. As each of the inner and outer stacks are comprised of inner and outer bearing stages, the deflection rate of each stack is a function of the deflection rate of the individual stage of which it is comprised. The stack deflection rate as used herein may be defined as the amount of axial deformation of either the inner stack or the outer stack in proportion to a compressive load applied along the same axis.

Because of the dissimilar deflection rates between the inner stack and the outer stack, inner stage 112 length B and outer stage 114 length A may be configured so they are substantially equal after assembly preloads are applied and when under a particular working load. To achieve this configuration, inner stage 112 length B and outer stage 114 length A may, therefore, be unequal in a free, or non-operating, state. A free state may be defined as before compressive assembly preloads are applied to the stacks of the turbodrill. Therefore, initially, the outer stage 114 free length A and inner stage 112 free length B may be unequal, however, after applying a compressive force, outer stage 114 length A and inner stage 112 length B are substantially equal due to the set differences in length. As the length of each stack is the sum of the length of its stages, if inner and outer stage lengths are equal in the compressed state then it follows that the overall lengths of the inner and outer stacks will also be equal.

For example, in certain embodiments, outer stage 114 may deflect less than inner stage 112 due to outer stage 114 having a larger cross-sectional area. Therefore, inner stage 112 may be configured with a free length B that is greater than free length A of outer stage 114. As a result, when placed under a compressive load, inner stage 112 will deflect greater than outer stage 114, and ultimately, compressed length A of outer stage 114 and compressed length B of inner stage 112 should be substantially equal. One of ordinary skill in the art will understand that the differences in the deflection rates of inner and outer stages may also be attributed to variances in materials used for the inner and outer stacks.

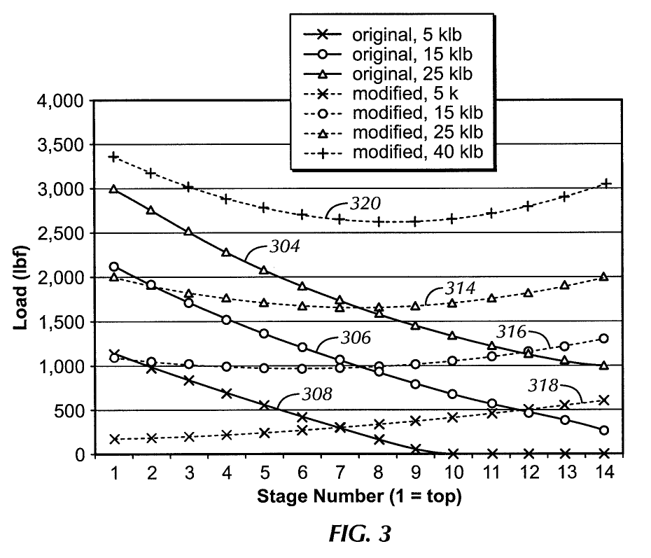

Referring to FIG. 3, a line chart illustrating comparisons between load distributions in a modified turbodrill having inner and outer stages with set unequal free lengths versus an unmodified turbodrill is shown in accordance with embodiments of the present disclosure. Lines 304, 306, and 308 represent the load distribution in an original turbodrill with unmodified inner and outer stage free lengths, and lines 314, 316, 318, and 320 represent the load distribution in a modified turbodrill having inner and outer stage free lengths that are unequal. In this modified version, the outer stage is configured having a free length A (FIG. 2B) that is 0.04 mm less than the inner stage free length B (FIG. 2B).

As shown, the unmodified turbodrill 304, 306, 308 shows an uneven load distribution across the stages of the bearing assembly. The upper stages have greater axial loads present, after which the axial loads begin to decrease towards the bottom stages. In contrast, the modified turbodrill 314, 316, 318, 320 employing unequal pre-assembly inner and outer stage free lengths, shows axial loads which are more evenly distributed across the bearing assembly of the turbodrill.

Additional improvement may be made by setting unique inner and outer stage lengths based on relative position within a stack. For example, the free state length of the inner stages at the top of the stacks may be slightly longer than the free state lengths of the inner stages at the bottom of the stack. Alternatively, if needed, this configuration may be reversed such that the free state length of inner stages at the bottom of the stack may be slightly longer than the free state lengths of the inner stages at the top of the stack.

In a second embodiment, deflection rate values of different components may be used to improve the load sharing ability of a multi-stage thrust bearing. Every component has a deflection rate, or “k”, similar to a spring constant of a common helical compressive spring. The deflection rate is defined as the rate at which the length of the component changes in proportion to the load applied to it along the same axis. Within a range, this rate is linear and proportional to variables which include: the cross-sectional area (A) perpendicular to the axis, the length along the axis (L), and the modulus of elasticity of the material (E). In equation form, the variables are arranged as such:

$$k = \frac{AE}{L}$$

In this embodiment, the geometry and/or materials of the inner and outer stages may be modified to “pair” or “match the k's,” such that the k of the inner stage is paired or matched to the k of a corresponding outer stage. The values of k for the inner and outer stages may be matched or paired by machining the components to change the cross-sectional geometry, or by using materials for the inner and outer stages that have a different modulus of elasticity. The “k matching” between the inner and outer stages may result in the inner and outer stage lengths being similar when the stacks are assembled in the free state as well as when under working load conditions.

In a third embodiment, the inner bearing stack and outer bearing stack may be assembled with different compressive loads (“compressive load compensation”) to achieve similar deflections between the inner stack and the outer stack. A compressive load will deflect the stacks proportional to the stack “k” value, which as previously mentioned, depends on the cross-sectional area (A) perpendicular to the axis, the length along the axis (L), and the modulus of elasticity of the material (E). The normal compressive loads may be adjusted such that the deflection of the outer stack is substantially equal to the deflection of the inner stack. The stiffer stack (typically the outer stack) will require a greater compressive load than the less stiff stack (inner stack), such that the resulting deflections are substantially equal. A spacer length adjustment may be used to achieve differing compressive loads.

For example, in a 4¾″ turbodrill having 14 hydraulic bearing stages, it may be desired that deflection of each outer stack stage be equal to the deflection of each inner stack stage. Calculations show that a compressive load of 221 kN on the inner stack stage will yield an inner stack stage deflection of 0.123 mm, and a total inner stack deflection (includes all 14 stages) of 1.722 mm. A similar amount of deflection is desired in the outer stack stage such that the inner and outer stacks have equal lengths. Calculations show that a compressive load of 406 kN on the outer stack stage yields an outer stack stage deflection of 0.123 mm, and a total outer stack deflection (includes all 14 stages) of 1.722 mm. Thus a compressive load of 406 kN on the outer stack is shown to provide similar deflection as 221 kN compressive load on the inner stack. In comparison, in a particular example of prior art design, a compressive load of 221 kN was applied to the outer stack, resulting in a deflection of only 0.940 mm. The free length of the stacks was equal, but the difference between outer and inner stack lengths when compressed was 1.722−0.940=0.782 mm. This condition significantly affected the ability of the bearing stages within the stack to share load equally. This example is simplistic in that its operating loads are not considered, and only compression preload is adjusted to achieve load sharing. Those skilled in the art will appreciate that a complete analysis must include operating loads and that compressive preloads, stage lengths, materials, and geometries of the components of the inner and outer stacks may be varied to improve load sharing.

Embodiments of the present disclosure may provide a load distribution through the multiple bearing assembly stages of the turbodrill, such that when under normal operating loads, the load on the most lightly-loaded bearing is within 25% of the load on the most highly-loaded bearing. Further, embodiments disclosed herein may provide a load distribution through the multiple bearing assembly stages of the turbodrill, such that when under normal operating loads, the load on the most lightly-loaded bearing is within 15% of the load on the most highly-loaded bearing.

Advantageously, embodiments of the present disclosure provide for more even load distribution among stages throughout the length of the bearing assembly because the inner and outer stack heights are equal under compression preloads and working loads. The even load distribution may lead to less bearing wear, higher load capacity for the same number of stages, and reduced likelihood of catastrophic failure. The unequal stage free length method may be advantageous as a simple method, because once the length difference is calculated, stage lengths may be modified to easily achieve the desired results. Further, by matching the deflection rate values of inner and outer stack components, the free state heights of the stacks may be equal, and the load distribution will be more consistent over a broad range of compressive and working loads, because both the inner and outer stack will deflect at a similar rate. Finally, the compressive load compensation method may be advantageous because it does not require any modification of the components, only of the assembly values used when applying the compressive pre-loads.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A drilling motor comprising:
an upper end connection adapted to connect to a drill string, and a lower end connection adapted to connect to a drill bit; and
a thrust bearing assembly having a plurality of stages assembled in a stack, each stage comprising:
at least one rotating inner bearing subassembly configured to contact at least one corresponding stationary outer bearing subassembly;
wherein axial loads among the plurality of stages are substantially equal under normal operating conditions.

2. The drilling motor of claim 1, wherein an inner bearing subassembly length and an outer bearing subassembly length are substantially equal under normal operating conditions.

3. The drilling motor of claim 2, wherein an inner bearing subassembly free length and an outer bearing subassembly free length are unequal in a free state.

4. The drilling motor of claim 1, wherein an inner bearing subassembly deflection rate is substantially equal to an outer bearing subassembly deflection rate.

5. The drilling motor of claim 1, wherein a first compressive preload is applied to the inner bearing subassembly and a second compressive preload is applied to the outer bearing subassembly during assembly.

6. The drilling motor of claim 5, wherein the compressive loads deflect the inner subassembly and the outer subassembly substantially the same amount.

7. The drilling motor of claim 1, further comprising polycrystalline diamond compact contact surfaces between the inner bearing subassembly and the outer bearing subassembly.

8. The drilling motor of claim 1, wherein the axial load on each bearing subassembly is within 25% of the axial load on the most highly loaded bearing subassembly in the drilling motor.

9. The drilling motor of claim 1, wherein the axial load on each bearing subassembly is within 15% of the axial load on the most highly loaded bearing subassembly in the drilling motor.

10. The drilling motor of claim 1, wherein the drilling motor is a turbodrill.

11. The drilling motor of claim 1, wherein the drilling motor is a mud motor.

12. The drilling motor of claim 1, wherein a bearing subassembly free length is varied such that the axial load distribution between each stage is substantially equal.

13. The drilling motor of claim 1, wherein a bearing stage deflection rate is varied such that the axial load distribution between each stage is substantially equal.

14. The drilling motor of claim 1, wherein a compressive assembly preload is varied such that the axial load distribution between each stage is substantially equal.

15. A method of improving a load distribution in thrust bearings of a drilling motor, the method comprising:
providing a multi-stage thrust bearing assembly having a plurality of rotating inner bearing subassemblies configured to contact a plurality of stationary outer bearing subassemblies; and
providing a bearing subassemblies having substantially equal axial loads under normal operating conditions.

16. The method of claim 15, further comprising selecting a length of the inner bearing subassembly and a length of the outer bearing subassembly, wherein the lengths are substantially equal when placed under a compressive load during assembly.

17. The method of claim 15, further comprising modifying the geometry of the inner bearing subassembly and the outer bearing subassembly such that a deflection rate of the inner bearing subassembly is substantially equal to the outer bearing subassembly.

18. The method of claim 15, further comprising applying a compressive load on the inner bearing subassembly and a compressive load on the outer bearing subassembly, wherein the compressive loads deflect the inner bearing subassembly and the outer bearing subassembly substantially the same amount.

19. The method of claim 15, further comprising providing an inner bearing subassembly length that is unequal to an outer bearing subassembly length before an assembly compression load is applied.

20. The method of claim 15, further comprising providing a load distribution such that the axial load on each bearing subassembly is within 25% of the axial load on the most highly loaded bearing subassembly in the drilling motor.

21. The method of claim 15, further comprising providing a load distribution such that the axial load on each bearing subassembly is within 15% of the axial load on the most highly loaded bearing subassembly in the drilling motor.
